(19) United States
(12) Patent Application Publication
(10) Pub. No.: US 2007/0115616 A1
(43) Pub. Date: May 24, 2007

(54) MOUNTING SYSTEMS AND METHODS FOR, E.G., UNINTERRUPTED POWER SUPPLIES AND THE LIKE

(75) Inventor: Mark A. Vackar, Round Rock, TX (US)

Correspondence Address: WATCHSTONE P+D, PLC, 1250 CONNECTICUT AVENUE, N.W., SUITE 700, WASHINGTON, DC, 20036-2657, US

(73) Assignee: TOSHIBA INTERNATIONAL CORPORATION, Washington, DC (US)

(21) Appl. No.: 11/555,068

(22) Filed: Oct. 31, 2006

Related U.S. Application Data
(60) Provisional application No. 60/732,006, filed on Oct. 31, 2005.

(51) Int. Cl. H02B 1/00

(52) U.S. Cl. 361/601

(57) ABSTRACT

An assembly for latching together electrical components and the like is disclosed. In some embodiments, the assembly includes a latching mechanism that is used to latch together an uninterrupted power supply (UPS) system chassis having at least one electrical connector to electrically connect to at least one modular unit. In some embodiments, the latch mechanism is configured to draw one of said at least one modular unit laterally in a side-to-side direction against said support chassis from an unlatched position in which said at least one electrical connector of said support chassis and said at least one corresponding electrical connector of said one of said at least one modular units are disengaged to a latched position in which said at least one electrical connector of said support chassis and said at least one corresponding electrical connector of said one of said at least one modular units are engaged.

### BACKGROUND OF THE INVENTION

1. Field of the Invention

The preferred embodiments of the present invention relate to mounting systems for, inter alia, uninterruptible power supply (UPS) systems, and, in some preferred embodiments, to systems and methods for mounting UPS modules in a UPS system.

2. Description of the Related Art

An uninterruptible power supply (UPS) is typically used as a buffer between commercially supplied power and an electrical load, such as, e.g., a computer, an analyzer or other electronic equipment. Typically, if line voltage is interrupted, power to the load can be maintained for a limited amount of time, such as, for example, to operate the load during the interruption or to provide time to properly shut down the load without resultant damage. By way of example, an on-line UPS commonly includes a converter, an inverter, and a battery charger. The UPS typically converts the commercially supplied AC power to DC power and then back to AC power This conversion, for example, isolates the load equipment from spikes and drops in the commercially supplied power and corrects variances in line voltages. Typically, DC power is used to charge a battery. Then, the battery can be used to supply AC power to the load when the commercially supplied power is interrupted

In some commercial applications, loads may change over time. As computer networks are expanded, the loads on a UPS system increase. In order to meet this increasing demand, either a larger UPS system is needed at the onset or, alternatively, a plurality of modular UPS units can be connected together as needed to meet the increasing requirements in power level. Known designs for a modular UPS systems have utilized one of two basic concepts. The first concept is to make each module an independent chassis. In such cases, the modules can then be stacked or piled next to each other in order to make the necessary electrical connections. One problem with this concept is that it is difficult to move the unit and changing a module may require modules to be disconnected during the operation of the system. The second concept of designing a modular UPS has been to build a freestanding chassis that is essentially a large receptacle for the modules. This design overcomes problems of mobility and service, but can increase the size of the unit, make the unit more difficult to manufacture, and limit field expandability. Thus, there is a need for a modular UPS unit that is easy to maintain, expandable and easy to manufacture.

An illustrative modular UPS system is shown in U.S. Pat. No. 6,317,348 (the '348 patent), of the present inventor, the entire incorporated herein by reference in its entirety. In this regard, FIG. 12(A) of the present application is a reproduction of FIG. 1 from the '348 patent. FIG. 12(A) is a block diagram of a UPS system 10 according to an embodiment of the '348 patent. As shown, the UPS system 10 comprises a plurality of panels 20, a base 40 and a plurality of modular UPS units 50. The plurality of panels 20 is connected together to form an internal chassis or central support structure. By utilizing a central support structure, the UPS system is mobile and each UPS modular unit 50 can be removed from the central support structure independent of the other modular UPS units, thus allowing for hot swapping of the modular UPS units. By using the central support structure, the manufacture of the UPS system is simplified, the size of the system is minimized, and the UPS system can be expanded in the field.

For further reference, FIG. 12(B) of the present application is a reproduction of FIG. 9 of the '348 patent. FIG. 12(B) illustrates how each modular UPS unit 50 is attached to the central support structure according to the '348 patent. In this regard, each panel has a plurality of male fasteners or clips 34. Each modular UPS unit 50 has a plurality of female fasteners or latches 52 arranged so that they align with the male fasteners on a section of each panel. The modular UPS units are attached to the central support structure by a pair of clips 34 on each panel that snap into matching latches 52 inside each modular UPS unit 50. In addition, each modular UPS unit 50 has input/output connectors 54 which connect to the input/output connectors 36 on the central support structure to electrically connect the modular UPS units 50 to the UPS system 10.

While a variety of UPS systems and methods are known, there remains a need in the art for improved systems and methods.

### SUMMARY

The preferred embodiments of the present invention can significantly improve upon existing systems and methods.

According to some of the preferred embodiments, an innovative latch structure is provided that enables the latching together of two objects, separated by a given distance, while concealing the latching mechanism and while having the latch perform the action of pulling the two objects together. Among other things, according to some of the preferred embodiments, a novel latch structure that includes, in some preferred embodiments, offset the pivot points between an actuating element and a hook element such that, among other things, the parts do not have to be co-planar (e.g., and, thus, do not need to be along the front of the unit) and the travel distance of the latch can be greatly extended. Among other things, the preferred embodiments can enable the latching mechanism to be concealed from the portion of the device exposed to the user during normal usage and can have great functional advantages over existing structures.

According to some embodiments, a method of mounting UPS modules on a UPS chassis, the UPS modules being removable from the UPS chassis independently of one another, is performed that includes: providing a UPS chassis having a plurality of I/O connectors electrically connectable to a plurality of UPS modules; in a first step, positioning a UPS module on the chassis at an unlatched position in which the UPS module is supported adjacent the chassis while the UPS module is not powered and is not connected to I/O connectors of the chassis; and in a second step, with a manually-operated latching mechanism, drawing the UPS module laterally in a side-to-side direction to the UPS chassis such that during the second step the UPS module becomes powered and becomes connected to I/O connectors of the chassis.

In some embodiments, the method further includes that in the first step, the positioning includes laterally sliding the UPS module on the chassis in a front-to-rear direction. In some examples, in the second step, a manually-operated latching mechanism is operated, wherein a handle section of the latching mechanism extends outward from a front surface of the chassis and a locking element of the latching mechanism extends outward from a side surface of the chassis facing the UPS module. In some examples, the latching mechanism includes an actuator that has the handle section, the actuator being pivotally mounted in a manner to extend outward of a through-hole in the chassis, and the latching mechanism includes a locking arm pivotally attached to an inner position on the actuator, the locking arm including the locking element proximate an inner end thereof. In some examples, the locking element is a hook or a catch pin that is configured to engage a keeper attached to a side of the module.

According to some other embodiments, an assembly for latching together electrical components is provided that includes: a support chassis having at least one electrical connector to electrically connect to at least one modular unit; at least one modular unit having at least one corresponding electrical connector to electrically connect to the support chassis; a latch mechanism configured to draw one of the at least one modular unit laterally in a side-to-side direction against the support chassis from an unlatched position in which the at least one electrical connector of the support chassis and the at least one corresponding electrical connector of the one of the at least one modular units are disengaged to a latched position in which the at least one electrical connector of the support chassis and the at least one corresponding electrical connector of the one of the at least one modular units are engaged, wherein the latch mechanism includes an actuator that is pivotally mounted on one of the one of the at least one modular units and the chassis and a latching arm that is pivotally mounted to the actuator in a manner to offset pivot points between a manually operated actuating element and a latching element.

In some examples, the latching element is a hook or a catch pin configured to engage a corresponding keeper on the other of the one of the at least one modular unit and the chassis. In some examples, the actuator includes a handle section that is located on a plain substantially parallel to a front side of the one of the at least one modular unit and the chassis while in the latched position and the latching arm is positioned in an offset-plain to a rear side of the plain. In some examples, the offset-plain is internal to the one of the module and the chassis such that the locking arm is substantially obstructed from view from a front side of the one of the at least one module and the chassis when in the latched position. In some other examples, the assembly further includes a switch located such as to be engaged upon moving of the latching mechanism into the latched position. Preferably, the latching mechanism is configured such that upon movement of the latching mechanism from the unlatched position to the latched position, the switch is first activated so as to start the modular unit and then the contacts are engaged.

According to some other embodiments, a latching mechanism for latching together electrical components is provided that includes: a latch mechanism configured to draw one component laterally in a side-to-side direction against another component from an unlatched position in which a connector of one component and a connector of the another component are disengaged to a latched position in which the connector of the one component and the connector of the another component are engaged, wherein the latch mechanism includes an actuator that is pivotally mounted on the one component and a latching arm that is pivotally mounted to the actuator in a manner to offset pivot points between a manually operated actuating element and a latching element.

The above and/or other aspects, features and/or advantages of various embodiments wilt be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is a perspective view showing a latch mechanism on a chassis according to some illustrative embodiments of the invention;

FIG. 2 is a top view of a latch mechanism shown in FIG. 1 within a chassis (depicted in phantom to facilitate viewing of the latch mechanism) according to some illustrative embodiments of the invention;

FIG. 3 is a top view of a prior art draw latch demonstrating deficiencies of some prior art mechanisms;

FIG. 4 is a perspective view of an actuator element according to some preferred embodiments of the invention;

FIG. 5 is a perspective view of a locking arm according to some preferred embodiments of the invention;

FIG. 6 is a perspective view of a keeper element according to some preferred embodiments of the invention;

FIG. 7 is a perspective view of a latch mechanism according to some preferred embodiments of the invention, including the actuator element shown in FIG. 4, the locking arm shown in FIG. 5 and the keeper element shown in FIG. 6;

FIG. 8 is a schematic diagram showing a top view of a module in an unlatched state adjacent a chassis;

FIG. 9(A) is a top view of a module in an un-latched state adjacent a chassis;

FIG. 9(B) is a perspective view of a UPS unit with a plurality of modules attached to a chassis according to some embodiments of the invention, showing all modules in a latched state;

FIG. 9(C) is another perspective view of a UPS unit with a plurality of modules attached to a chassis according to some embodiments of the invention, showing one module in an unlatched state;

FIG. 9(D) is a top perspective view of a portion of a UPS unit showing an illustrative engagement between a module and a chassis in accordance with some embodiments of the invention, employing a C-shaped channel on the module that engages with a corresponding grooves in the chassis side wall;

FIG. 9(E) is a top perspective view depicting the engagement of illustrative C-shaped channels and grooves similar to the embodiment shown in FIG. 9(D) according to some illustrative embodiments;

FIG. 9(F) is a schematic side view depicting the engagement of illustrative C-shaped channels and grooves similar to the embodiment shown in FIG. 9(D) according to some illustrative embodiments;

FIG. 10 is a cut away top view depicting the engagement of a module and a chassis with the latching mechanism in an unlatched state according to some illustrative embodiments;

FIG. 11 is a schematic top view depicting the arrangement of a latching mechanism within a chassis according to some illustrative embodiments; and

FIGS. 12(A) and 12(B) are perspective views of a UPS system according to a prior invention of the present inventor.

### DETAILED DESCRIPTION

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein. The basic principle of the present invention will first be described below. This description is simplified for the convenience of easily understanding the present invention, and hence this example should not be taken as limiting the embodiments of the present invention.

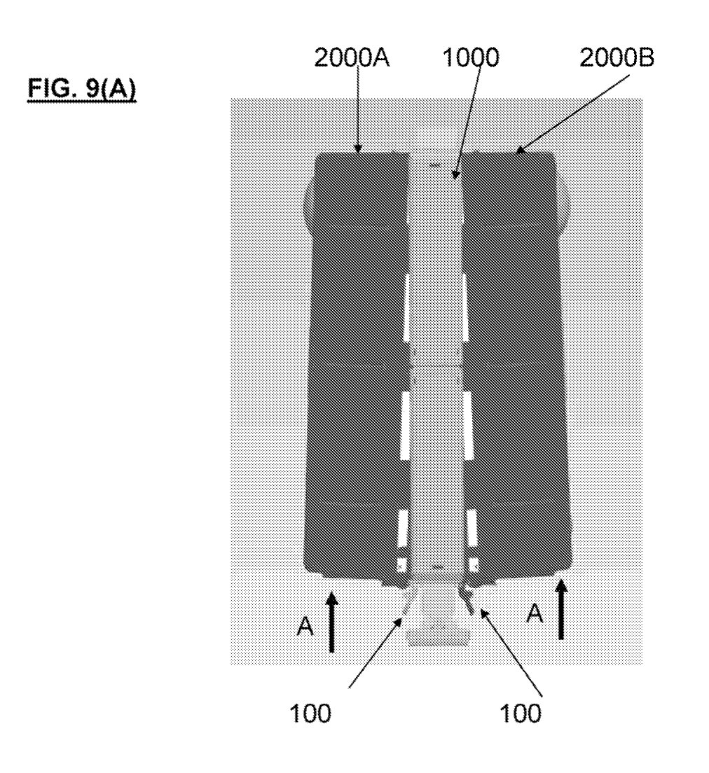

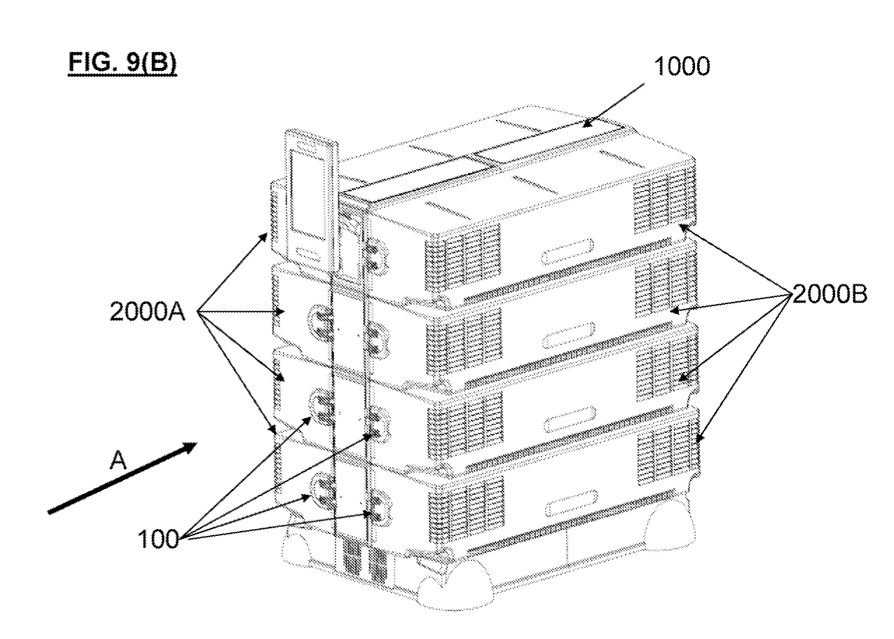

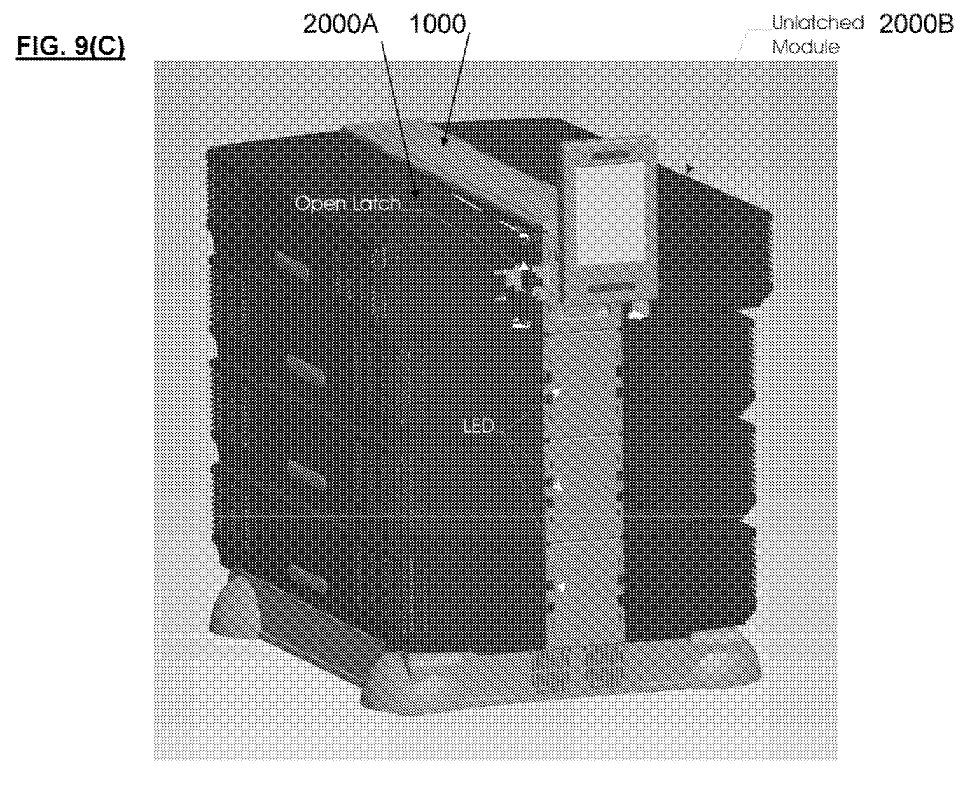

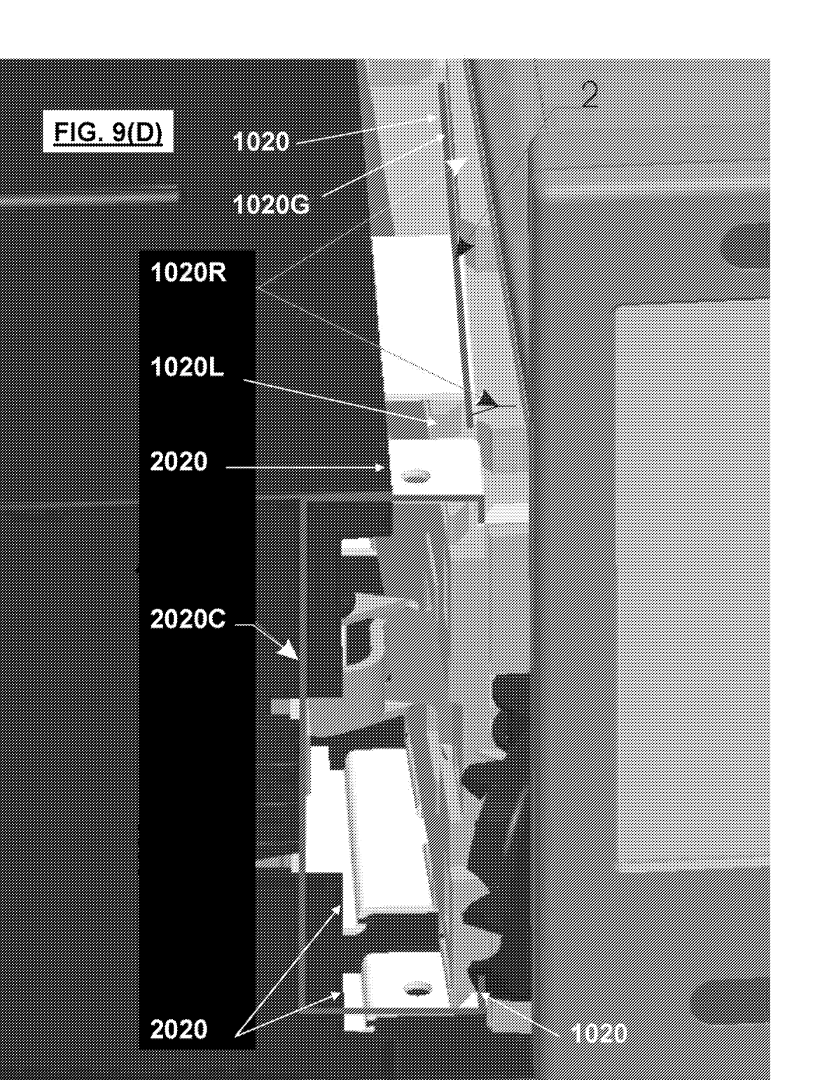

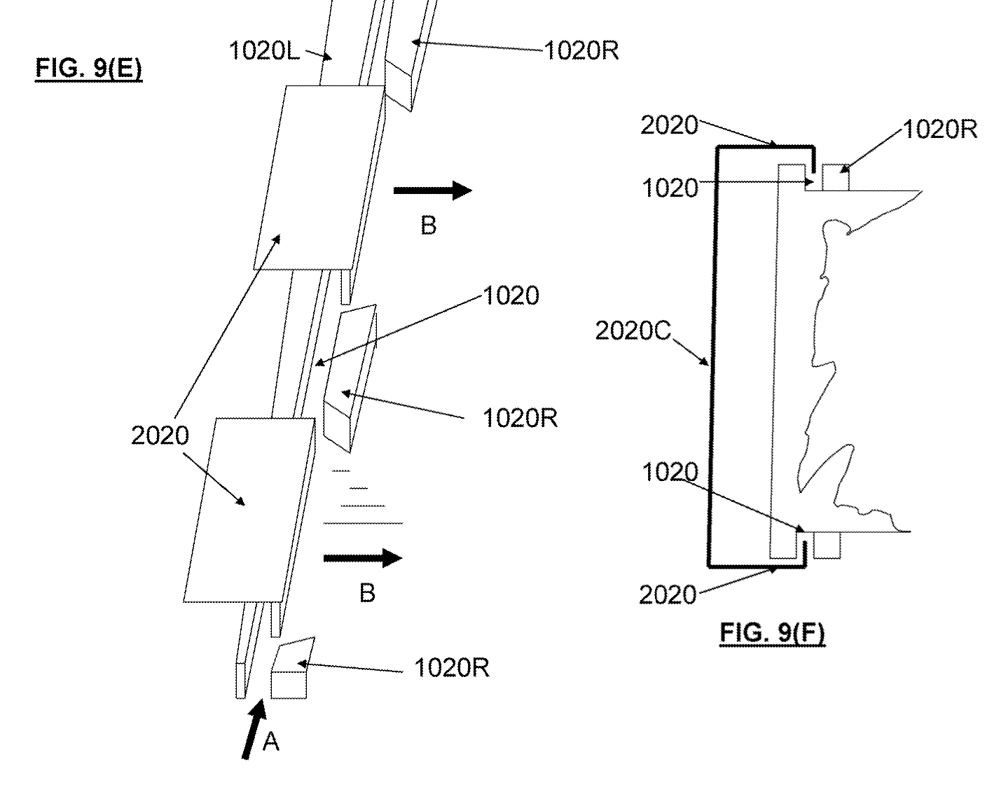

Referring initially to FIG. 9(B), a front perspective view of an illustrative UPS system according to some illustrative embodiments of the invention is depicted. As shown, the system includes a center chassis 1000 with a series of modules 2000 (including, in some preferred embodiments, left-side modules 2000A and/or right-side modules 2000B)) attached to either side of the center chassis. In some embodiments, the modules 2000 and the chassis 1000 can include components similar to that described in the above-referenced U.S. Pat. No. 6,317,348, the entire disclosure of which is incorporated herein by reference.

In accordance with the preferred embodiments of the invention, the modules 2000 are attached to the chassis 1000 using a novel attachment methodology, as described in detail below.

In this regard, preferably, the modules 2000 are mounted on the chassis 1000 in two stages: 1) in a first stage, a module 2000 is positioned upon the chassis 1000 in an unlatched state (see, e.g., modules 2000A and 2000B shown in FIG. 9(A)); and 2) in a second stage, the module 2000 is moved into a latched position (such as, e.g., modules 2000A and 2000B shown in FIG. 9(B)).

In some preferred embodiments, in order to place the modules onto the chassis into the unlatched state in the first stage, the modules 2000 are attached by sliding the modules onto the chassis 1000 from the front side of the chassis—e.g., in the direction of the arrows A shown in FIGS. 9(A), 9(B) and 9(E). in this regard, the modules 2000 and the chassis 1000 can be adapted so as to initially support the modules upon the chassis in the first stage in a variety of ways. While some preferred embodiments are described herein-below with reference to FIGS. 9(D) to 9(F), in various examples the modules 2000 can include flanges or other elements that slide within respective channels on the chassis 1000 (or vise verse). or the modules 2000 can include clips that engage the chassis 1000 and/or any other appropriate engagement mechanisms can be employed between the modules 2000 and chassis 1000. In some preferred embodiments, when the module 2000 is located in the first stage position (e.g., in an unlatched state), such as, e.g., in the position of module 2000A shown in FIG. 9(A), the module 2000 is angled slightly with respect to the chassis, with a rear end of the module closer to the chassis than a front end of the module. In some examples, this angle can be less than about 10 degrees, or, more preferably, less than about 5 degrees, or, in some preferred embodiments, about 2-½ degrees from a side surface of the chassis as best shown in FIG. 9(A).

With reference to FIGS. 9(D) to 9(F), in some embodiments the inside of the modules 2000 can include a plurality of C-shaped channels 2020C having upper and lower flange portions 2020 that are adapted so as to engage within respective grooves 1020 along the top and bottom of the outer side wall of the chassis 1000. With reference to FIG. 9(D), the C-shaped channel is drawn schematically at 2020C. It should be appreciated based on this disclosure that the C-shaped channels 2020C can include any appropriate shape and need not be C-shaped, as long as they include flanges that can fit within the grooves 1020. For explanatory purposes, FIG. 9(D) depicts flange portions 2020 situated within a groove 1020 (without showing the module 2000 or the chassis structure for simplicity) as a unlatched state when the module 2000 is inserted in the first stage onto the chassis. In this regard the flange of the C-shaped channel is inserted into the groove 1020 in the direction of the arrow A so as to follow within the groove 1020 between the left-side wall 1020L and between the right-side wall segments 1020R. In this illustrative embodiment, once the module 2000 is fully inserted to the unlatched position, the flange portions 2020 of the C-shaped channel sections are preferably aligned with openings between the right-side wall segments 1020R. In this manner, the second stage of the mounting can occur by causing the module 2000 to move relatively to the chassis 1000 in the direction of arrows B, such as, e.g., by use of the latching mechanism described below in some preferred embodiments of the invention. In some preferred embodiments, the edges of the segments 1020R are tapered (as shown) so as to facilitate positional alignment of the modules 2000 as they are drawn tightly against the chassis 1000. While in the foregoing example, left-side wall and right-side wall portions are described, it should be understood that in embodiments having modules on opposite or other sides of a chassis 1000, the arrangement of the side walls may vary based on the orientation from the chassis.

In some preferred embodiments in order to place the modules in a latched state on the chassis in the second stages, a novel latching mechanism, such as described below, is utilized. In this regard, as described above, the latching mechanism is preferably adapted so as to laterally move the module in such a manner that the module is pulled tightly against the chassis when drawn into the latched or closed state.

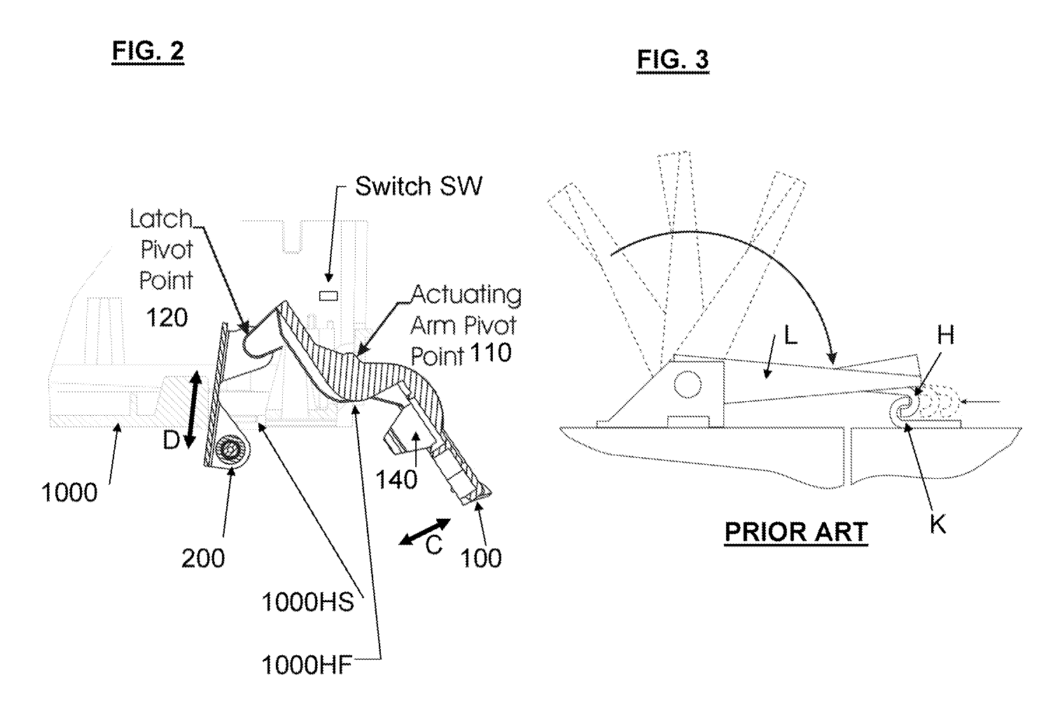

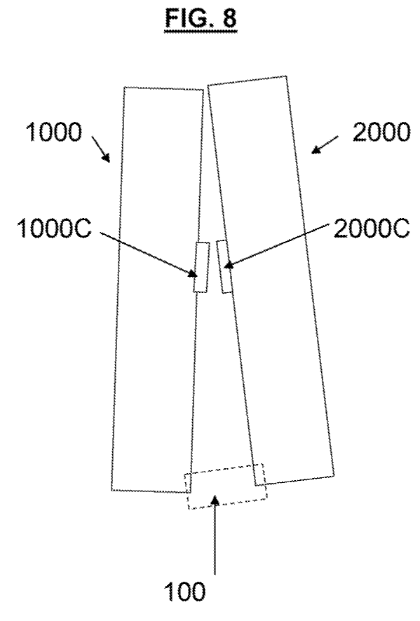

In some preferred embodiments, upon movement of the module into a latched or closed state the following occurs: 1) a switch (such as, e.g., switch SW shown in FIG. 2) is caused to close such that, by way of example, the system is turned on and/or an indication light shows a latched condition; and 2) electrical contacts (such as, e.g., connectors 1000C and 2000C shown in FIG. 8) between the module and the chassis are brought into electrical contact engagement. As schematically shown in FIG. 8, each UPS module 2000 preferably includes input/output connectors 2000C that connect to the input/output connectors 1000C on the central support chassis 1000 structure to electrically connect the UPS modules to the UPS system.

In some preferred embodiments, as one closes the latch mechanism, the switch is preferably first activated (at a certain point or position) so as to start the unit (e.g., to turn it on), and then the contacts are preferably engaged. On the other hand, upon opening the latch mechanism, preferably the switch is first opened (so as to turn off or kill the unit) and then the contacts are opened. By way of example FIG. 9(C) shows a plurality of LED indicator lights, with a single light adjacent respective modules.

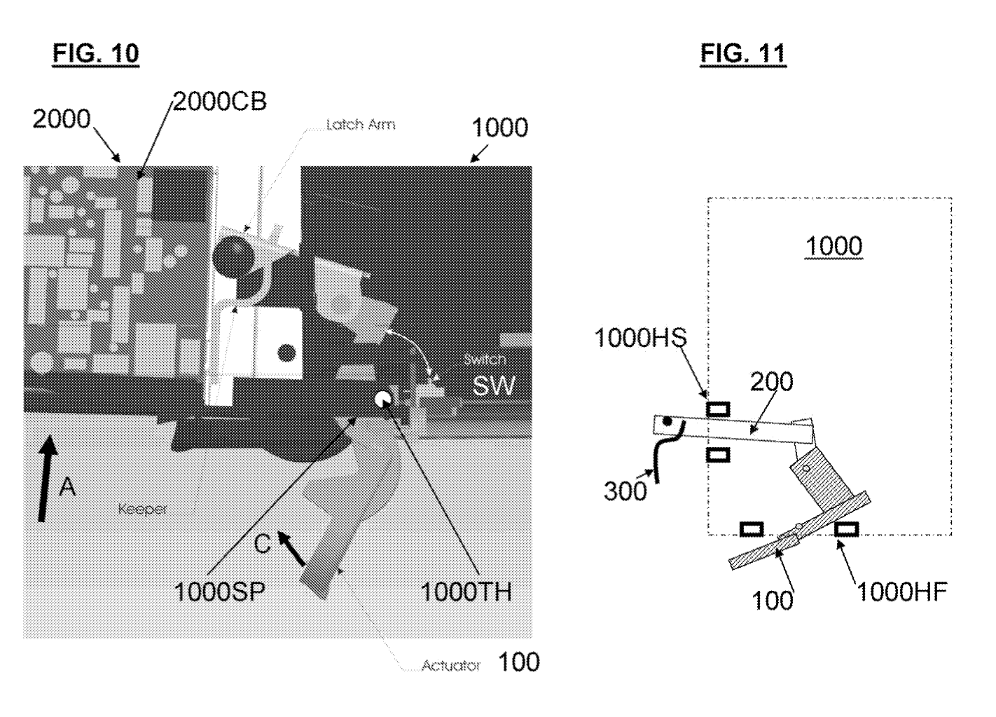

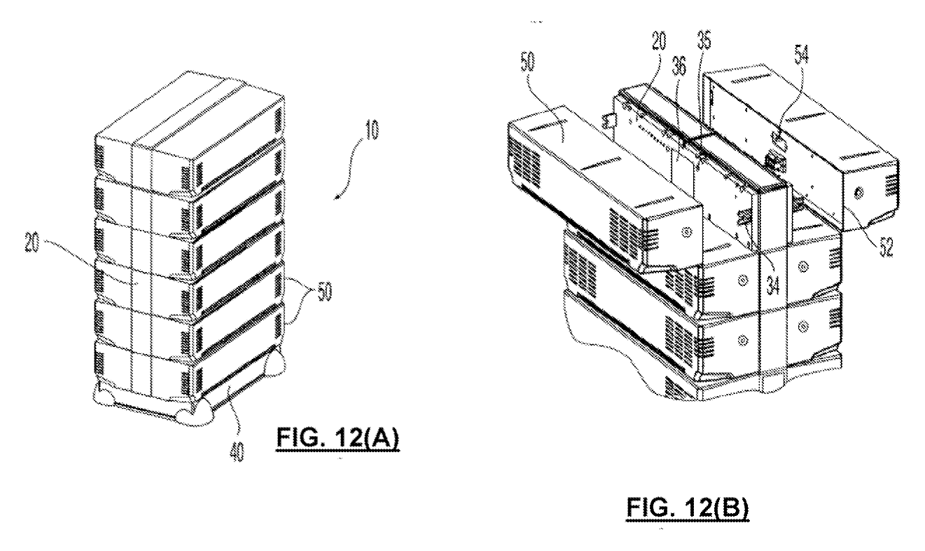

To facilitate reference, FIG. 10 depicts the latch mechanism in an unlatched state with the top of the module 2000 and the chassis 1000 cut away to facilitate viewing of the latch mechanism structure. As shown, during movement of the actuator 100 the actuator 100 causes a switch SW to be activated by the latch mechanism (such as, e.g., as described below a portion of the actuator 100 can physically cause the switch to close in some embodiments by pushing against the switch SW during movement of the latch mechanism to a closed state). Preferably, when the latch mechanism is closed the switch SW is also closed. The closing of the switch also preferably initiates a startup sequence for the module. When the latch mechanism is opened, the switch SW preferably also preferably opens and the module is preferably shutdown. As discussed above, the switch SW also preferably activates an LED or other indicator light.

In the preferred embodiments the latch mechanism includes an actuator portion 100 which can be, e.g., manually grasped by a user to open or close the latch mechanism. For reference, FIG. 9(A) shows a state with latch mechanisms in an open condition with actuators 100 positioned outward from the chassis 1000, and FIG. 9(B) shows a UPS assembly in which the modules 2000 are fully latched upon the chassis 1000, such that the actuators 100 are positioned in a closed or latched state flush against the side of the modules 2000.

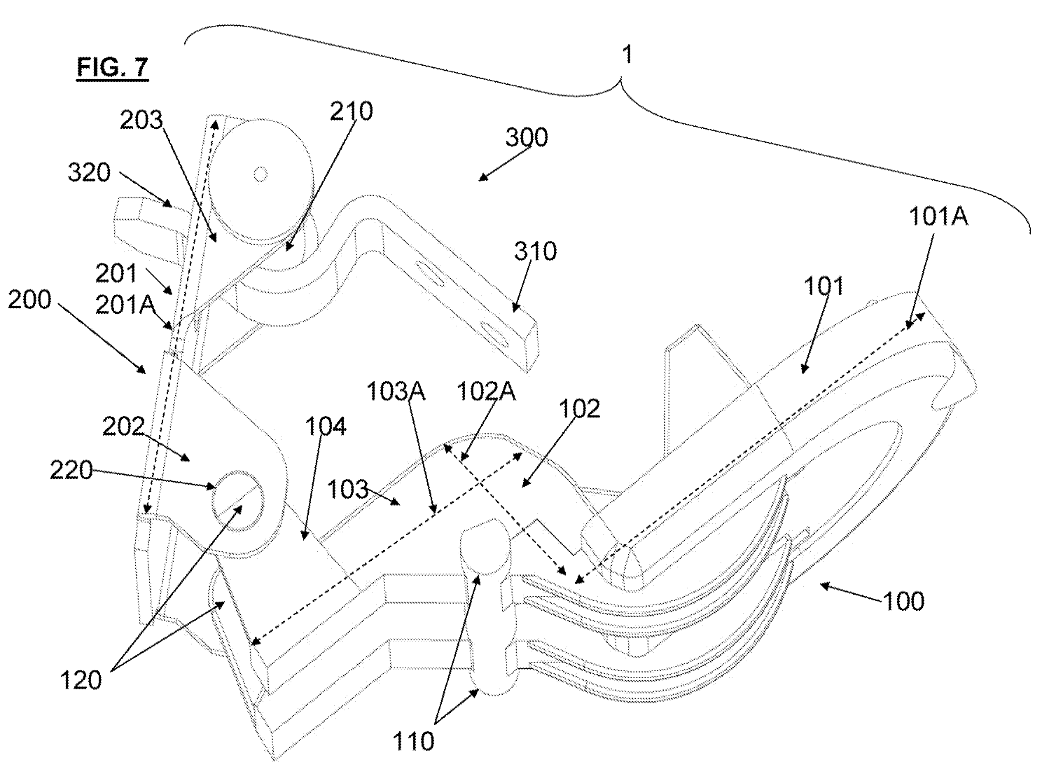

With reference to FIG. 7, in some embodiments, a latch mechanism 1 includes the following components. It is initially noted that, as shown in, e.g., FIG. 9(B), in some preferred embodiments, the actuator 100 is the only or substantially the only portion of the latch mechanism 1 which is visible during normal use of the latch mechanism (i.e., when the latch mechanism 1 is in a closed state). As shown in FIG. 7, the latch mechanism 1 preferably includes an actuator 100 portion that includes a handle section 101 which is visible during normal use, a set-back section 102 which extends back inside the front face of the module during normal use, an inner arm 103, and extension portions 104. As shown, the handle section 101 preferably extends substantially along a plane 101A (represented as a dashed-line). In operation, in an unlatched state, the plane 101A is located at an angle to the front face of the module (see, e.g., FIGS. 9(A) and 10) and is located substantially parallel to the front face of the module in a latched state (see, e.g., FIG. 9(B)). As shown in FIG. 7, the set-back section 102 preferably includes a pivot mechanism for enabling pivoting movement of the actuator 100 within the chassis 1000, such as, e.g., pivot pins 110 that extend therefrom which are pivotally engaged within receiving holes inside the chassis 1000. As further shown in FIG. 10, the module 1000 preferably includes support plates above and below the actuator 100 (a plate above the actuator is shown) having through-holes 1000TH for pivotally receiving the pivot pins 110. Referring again to FIG. 7, the set-back section is preferably set back a distance in the direction of arrows 102A.

As shown in FIG. 7, the inner arm 103 preferably extends generally parallel to the handle section 101 along the direction of the dashed-line arrows 103A. In addition, the extension portions 104 preferably extend further inside the chassis 1000 a distance as shown in FIGS. 7 and 10. The inner ends of the extension portions 104 preferably include pivot pins 120 that pivotally support a locking arm 200 described below.

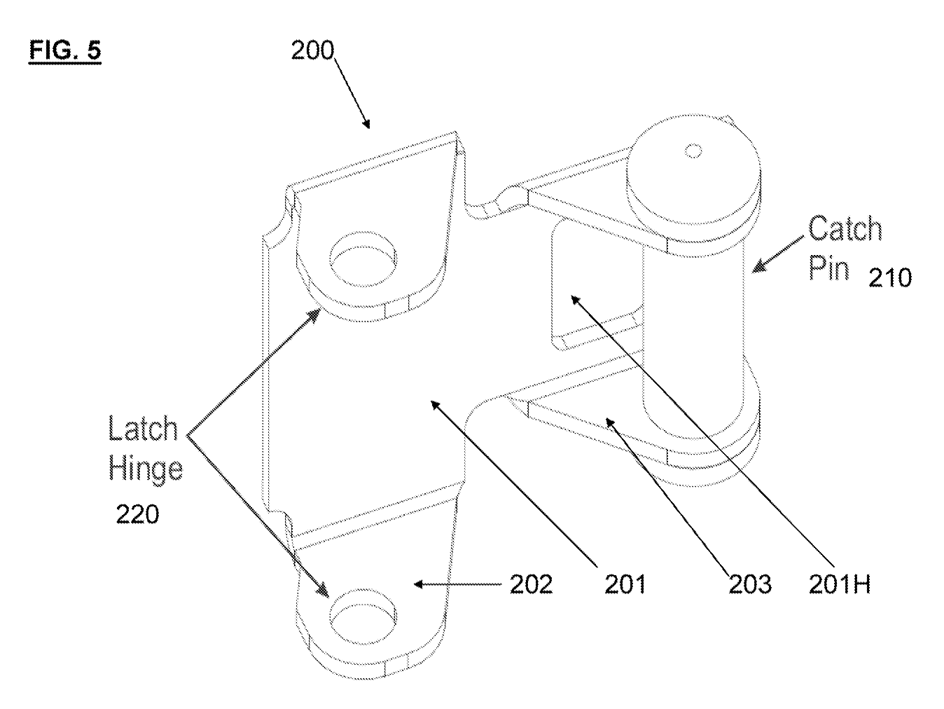

In some preferred embodiments, a locking arm or latch arm 200 is provided that includes a base portion 201, which can, e.g., include a substantially flat plate as shown in FIG. 7. The base portion 201 preferably supports actuator-engaging plates 202 at one end proximate to the actuator 100 and locking-pin-receiving plates 203 at a distal end of the base portion. As further shown in FIG. 7, the actuator-engaging plates preferably include through-holes 220 configured to pivotally receive the pivot pins 120. In addition, the locking-pin-receiving plates 203 preferably support a generally cylindrical locking pin or catch pin 210 thereupon. The details of the locking arm 200 are further depicted in FIG. 5. With reference to FIGS. 5, 7 and 10, in operation, the catch pin 210 of the locking arm 200 can be moved via the actuator 100 so as to engage a keeper 300 which is fixedly mounted to an outer surface of the chassis 100. In this manner, when the actuator 100 is positioned in the unlatched position on a chassis 1000, such as, e.g., in the position 2000A shown in FIGS. 9(A) and as shown in FIG. 10, the handle section 101 of the actuator 100 can be manually moved in the direction of the arrow C shown in FIG. 10 so as to cause the actuator to pivot around the pivot pins 110, such that the catch pin 210 is drawn in a direction clockwise around the pivot pins 110 or rightward in FIG. 10, whereby by engagement with the keeper 300, the module 2000 is moved with respect to the chassis 1000 into a latched state with the module tightly fitted against the chassis. Similarly, in order to unlatch the module 2000 from the chassis 1000, a user can grasp the handle section 101 and pull it outward until it reaches the position shown in FIG. 10. During such movement, the latch arm 200 is preferably caused to push against the keeper 300 (such as, e.g., via engagement with a side edge of the through-hole 201H) so as to cause the module 2000 to move outward relative to the chassis 1000 to the unlatched state shown in FIG. 10.

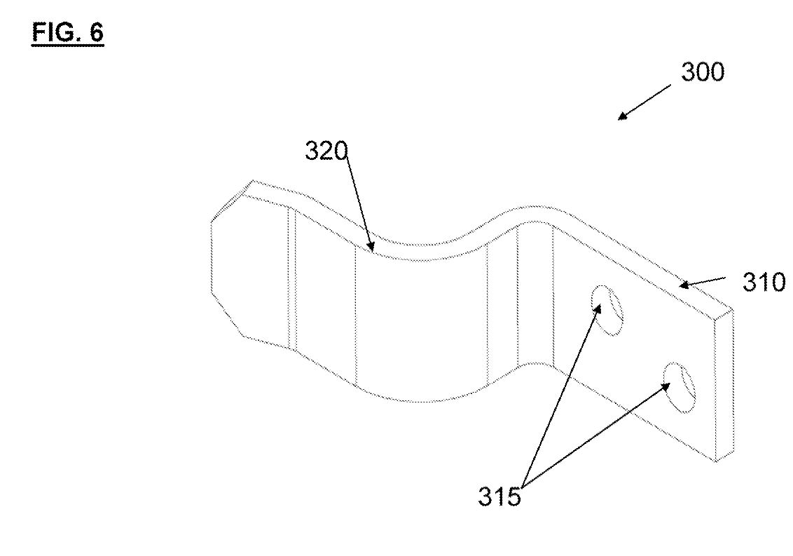

With reference to FIG. 6, in some preferred embodiments, the keeper 300 is configured so as to have a mounting plate section 310 which can be fixedly attached to the module 2000, such as, e.g., using bolts, screws or the like received via through-holes 315 in some illustrative examples, and a catch-pin-retainer section 320 which is configured so as to receive the catch pin 210 as shown and described herein. Preferably, the end of the retainer section 320 tapers outward slightly so as to facilitate engagement with the catch pin 210 when the module 2000 is slid onto the chassis in the direction of the arrows A shown in FIGS. 9(A), 9(B), 9(E) and 10.

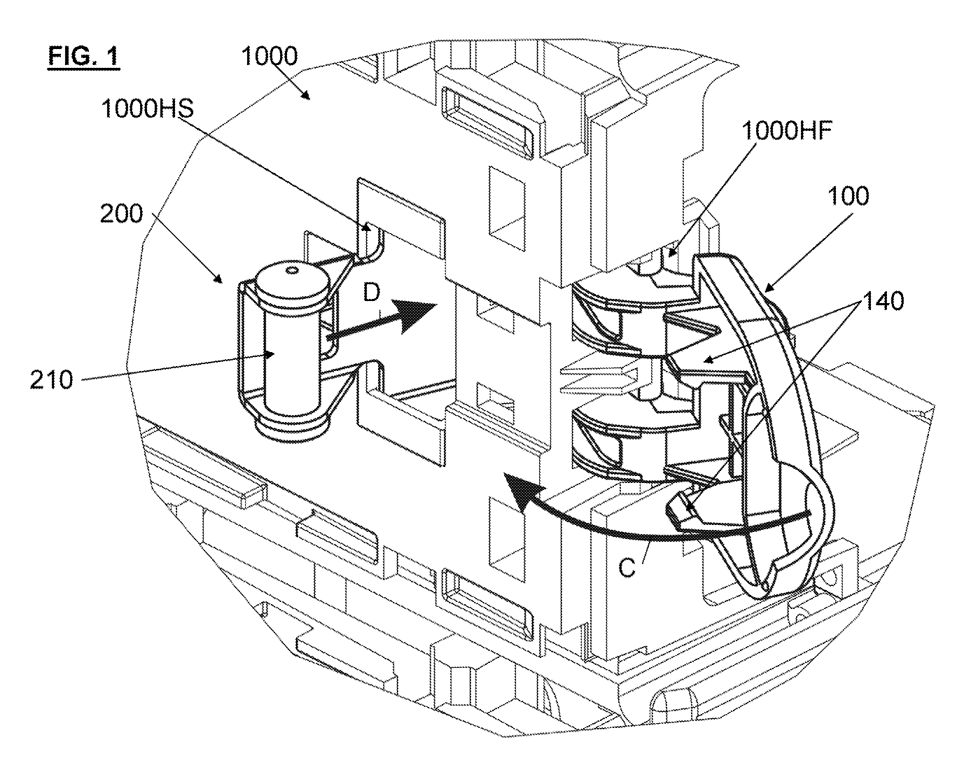

With reference to FIGS. 1, 2 and 10, the chassis 1000 preferably includes two through-holes via which components of the latch mechanism protrude from the chassis to varying extends depending on the positioning of the latch mechanism components during operation. In particular, the front of the chassis 1000 preferably includes a through-hole 1000HF through which the actuator handle-section 101 extends and the side of the chassis 1000 preferably includes a through-hole 1000HS through which the locking arm 200 extends. With reference to the schematic illustration in FIG. 11, the size of the through-holes can be advantageously minimized such that the components of the latch mechanism can be retained substantially internally to the chassis 1000. In addition, in view of the pivotal mounting of the locking arm 200, the sides of the through-hole 1000HS can be configured and positioned as desired so as to facilitate guiding of the latch arm 200 during its motion into and out of the chassis 1000 via the through-hole 1000HS.

With reference to FIGS. 1, 2, 7 and 10, the actuator preferably includes at least one engagement projection(s) 140 that extends inwardly from the handle section 101 and that is configured so as to engage (such as, e.g., to snap fit into) with respective receiving openings (not shown) in the module when in a latched state.

For further illustration, FIG. 1 shows a perspective view of the actuator 100 at the side of a chassis with the actuator in an open or unlatched state. As illustrated in embodiment shown in FIG. 1, when the handle section 101 is moved in the closing direction i.e., in the direction of the arrow C the locking pin or catch pin 210 is concurrently caused to move inward into the side through-hole 1000HS in the direction of the arrow D. Similarly, when the handle section 101 is moved in an opening direction opposite to that of the arrow C, the catch pin 210 is concurrently caused to move outward from the side through-hole 1000HS.

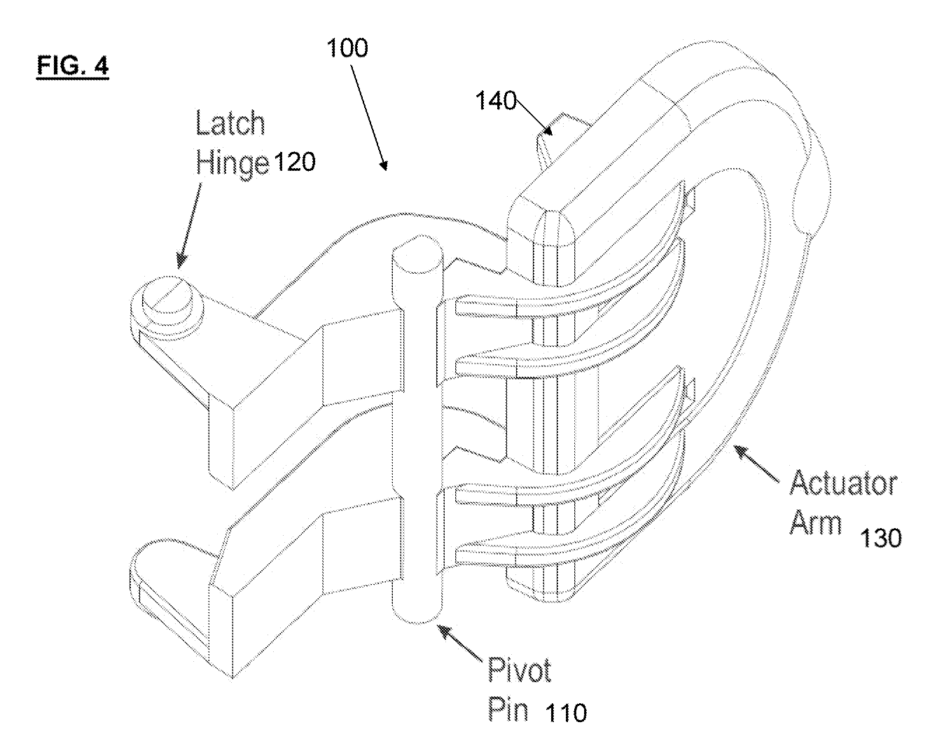

In the drawings, FIGS. 1, 2, 4, 5, 6 and 7 show illustrative components of the latch mechanism 1 with component parts shown substantially to scale in appropriate size proportions according to some illustrative embodiments. In various embodiments, however, the dimensions of the components and/or configurations of components can vary widely based on circumstances.

According to some of the preferred embodiments, an innovative latch structure is, thus, provided that enables the latching together of two objects, separated by a given distance, while concealing the latching mechanism and while having the latch perform the action of pulling the two objects together. A standard draw latch shown in FIG. 3 performs functions of latching two objects together, but it has some significant limitations. In this regard, as shown in FIG. 3, a standard draw latch has a lever L, a hook H and a keeper K. In operation, when the lever L is moved in, for example, the direction of the arrow shown in FIG. 3, a mechanism causes the hook H to move leftward so as to catch on the keeper K. The lever L can then be moved back, drawing the part that the keeper K is attached to toward the part that the lever L and hook H are attached to. In this type of latch the two parts are required to be co-planar. In such a case, while a standard draw latch can be used to pull two separate co-planar objects together and to latch them in place, the latch is fully exposed and has a limited travel distance.

Among other things, according to some of the preferred embodiments of the present invention, a novel latch structure is employed that includes offset the pivot points between an actuating element (e.g., actuator handle section 101) and the hook element (e.g., locking arm 200 and catch pin 210) such that among other things, the parts do not have to be co-planar (e.g., and, thus, do not need to be along the front of the unit) and the travel distance of the latch can be greatly extended. In the preferred embodiments, a pivot point of a hook H and lever L is, thus, moved out of alignment with a pivot point of the lever L, allowing for a number of improvements. First, of all the two parts no longer need to be in the same plane. Second, the travel distance of the hook can be increased thereby increasing the reach of the latch. Third the latch can be concealed leaving only the actuating lever exposed to the user. Concealing the latch not only offers cosmetic benefits, but also enhances the safety to the user by covering possible pinch points and other benefits.

Although a preferred embodiment of the invention has been described in the context of a UPS system, it is to be understood that the invention can be used in other systems made up of modular components. Additionally, while the invention has been illustratively described in its preferred form, it is not intended to limit the scope of the claims that follow the specifics of that design form, inasmuch as variations equivalent thereto are feasible without departing from the novel inventive concepts involved. These and other variations are contemplated to fall within the scope of the claims that follow.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

What is claimed is:

1. A method of mounting UPS modules on a UPS chassis, said UPS modules being removable from the UPS chassis independently of one another, comprising:
providing a UPS chassis having a plurality of I/O connectors electrically connectable to a plurality of UPS modules;
in a first step, positioning a UPS module on said chassis at an unlatched position in which said UPS module is supported adjacent said chassis while said UPS module is not powered and is not connected to I/O connectors of said chassis; and
in a second step, with a manually operated latching mechanism, drawing said UPS module laterally in a side-to-side direction to said UPS chassis such that during said second step said UPS module becomes powered and becomes connected to I/O connectors of said chassis.

2. The method of claim 1, wherein in said first step, said positioning includes laterally sliding said UPS module on said chassis in a front-to-rear direction.

3. The method of claim 1, wherein in said second step, a manually-operated latching mechanism is operated, wherein a handle section of the latching mechanism extends outward from a front surface of said chassis and a locking element of said latching mechanism extends outward from a side surface of said chassis facing said UPS module.

4. The method of claim 3, wherein said latching mechanism includes an actuator that has said handle section, said actuator being pivotally mounted in a manner to extend outward of a through-hole in said chassis, and said latching mechanism includes a locking arm pivotally attached to an inner position on said actuator, said locking arm including said locking element proximate an inner end thereof.

5. The method of claim 4, wherein said locking element is a hook or a catch pin that is configured to engage a keeper attached to a side of said module.

6. An assembly for latching together electrical components, comprising:
a support chassis having at least one electrical connector to electrically connect to at least one modular unit;
at least one modular unit having at least one corresponding electrical connector to electrically connect to said support chassis;
a latch mechanism configured to draw one of said at least one modular unit laterally in a side-to-side direction against said support chassis from an unlatched position in which said at least one electrical connector of said support chassis and said at least one corresponding electrical connector of said one of said at least one modular units are disengaged to a latched position in which said at least one electrical connector of said support chassis and said at least one corresponding electrical connector of said one of said at least one modular units are engaged, wherein said latch mechanism includes an actuator that is pivotally mounted on one of said one of said at least one modular units and said chassis and a latching arm that is pivotally mounted to said actuator in a manner to offset pivot points between a manually operated actuating element and a latching element.

7. The assembly of claim 6, wherein said latching element is a hook or a catch pin configured to engage a corresponding keeper on the other of said one of said at least one modular unit and said chassis.

8. The assembly of claim 6, wherein said actuator includes a handle section that is located on a plain substantially parallel to a front side of said one of said at least one modular unit and said chassis while in said latched position and said latching arm is positioned in an offset-plain to a rear side of said plain.

9. The assembly of claim 8, wherein said offset-plain is internal to said one of said module and said chassis such that said locking arm is substantially obstructed from view from a front side of said one of said at least one module and said chassis when in said latched position.

10. The assembly of claim 6, further including a switch located such as to be engaged upon moving of said latching mechanism into said latched position.

11. The assembly of claim 10, wherein said latching mechanism is configured such that upon movement of said latching mechanism from said unlatched position to said latched position, said switch is first activated so as to start the modular unit and then the contacts are engaged.

12. The assembly of claim 10, wherein upon said latching mechanism engaging said switch, an indicator light on a front of said assembly is activated.

13. A latching mechanism for latching together electrical components, comprising:
a latch mechanism configured to draw one component laterally in a side-to-side direction against another component from an unlatched position in which a connector of one component and a connector of said another component are disengaged to a latched position in which said connector of said one component and said connector of said another component are engaged, wherein said latch mechanism includes an actuator that is pivotally mounted on said one component and a latching arm that is pivotally mounted to said actuator in a manner to offset pivot points between a manually operated actuating element and a latching element.

14. The latching mechanism of claim 13, wherein said latching element is a hook or a catch pin configured to engage a corresponding keeper on said another component.

15. The latching mechanism of claim 13, wherein said actuator includes a handle section that is located on a plain substantially parallel to a front side of said one component while in said latched position and said latching arm is positioned in an offset-plain to a rear side of said plain.

16. The latching mechanism of claim 15, wherein said offset-plain is internal to said one component such that said locking arm is substantially obstructed from view from a front side of said one component when in said latched position.

17. The latching mechanism of claim 13, further including a switch located to be engaged upon moving of said latching mechanism into said latched position.

18. The latching mechanism of claim 17, wherein said latching mechanism is configured such that upon movement of said latching mechanism from said unlatched position to said latched position, said switch is first activated and wherein said one component and said another components are electrical components, and said one component is activated by said switch and then electrical contacts between said one component and said another component are engaged upon said movement of said latching mechanism.

19. The latching mechanism of claim 17, wherein upon said latching mechanism engaging said switch, an indicator light on a front of said assembly is activated.
